(19) United States
(12) Patent Application Publication
(10) Pub. No.: US 2026/0296971 A1
(43) Pub. Date: Oct. 1, 2026

(54) COMPOSITION, PRODUCTION AND APPLICATION USE METHOD OF ASPHALT BINDER MODIFIED WITH WASTE MATERIAL IN TACK COAT

(71) Applicant: SÜLEYMAN DEMIREL ÜNIVERSITESI IDARI VE MALI ISLER DAIRE BASKANLIGI GENELSEKRETERLIK, MERKEZ ISPARTA (TR)

(72) Inventors: Mehmet SALTAN, ISPARTA (TR); Öznur KARADAG, ISPARTA (TR); Gizem KAÇAROGLU, ISPARTA (TR)

(21) Appl. No.: 19/479,354

(22) PCT Filed: Jun. 23, 2023
(86) PCT No.: PCT/TR2023/050616

§ 371 Date: Oct. 28, 2025

(51) Int. Cl. C04B 26/26; C04B 111/00

(52) U.S. Cl. CPC C04B 26/26; C04B 2111/00482

(57) ABSTRACT

The invention relates to the composition of an asphalt binder modified with bio-oil obtained from the pyrolysis of waste recycled polypropylene (PP) in granular form in a ratios of 1 to 3%, to the production of a 50/70 asphalt binder which is formed by using the wet method and modified with bio-oil material, and to its application to the tack coat between the binder and the wearing courses.

This application is a National Phase entry of International Application No. PCT/TR2023/050616 under § 371, filed Jun. 23, 2023, which is hereby incorporated by reference in its entirety.

### TECHNICAL FIELD

The disclosure relates to the production and application method of asphalt binder composition modified with waste material, which is applied as a tack coat bonding wearing and binder courses, aiming to reduce fatigue and thermal cracks occurring in the pavement and to reduce environmental pollution by using recycled materials.

The disclosure particularly relates to asphalt binder composition modified with bio-oil which obtained from the pyrolysis of waste recycled polypropylene (PP) in granular form, to the modification of the asphalt binder with the bio-oil material using a wet process, and to its application to the tack coat between the binder and the wearing courses.

### BACKGROUND

Tack coats are applied to ensure the bonding of the reinforcement layer or hot mix asphalt layers with the existing pavement on highways. Interfacial bond between asphalt layers plays an important role in the mechanical behavior of the pavement and its strength and fatigue performance.

In the case of failure to apply sufficient tack coat between pavement layers may result in deterioration such as slipping crack, fatigue crack, and delamination. Due to the weak bonding of the pavement layers, slipping, fatigue crack, and delamination deteriorations are very common, especially in places where braking and acceleration are frequent, such as intersections.

The cost of repairing the deterioration of the pavement is higher than the cost of the tack coat applied between the pavement layers. Therefore, a good bonding between the pavement layers should be established. To ensure good asphalt pavement performance, cost reduction, and long service life, developing asphalt binders in the state of the art was necessary.

A vast amount of expenditures happens during the repair of deteriorations caused by poor bonding of the asphalt layers. Since bitumen emulsions used as tack coats must be used in a given time after their preparation, the application of such materials is not always realized. In addition to decreasing the performance of pavements, these situations have a negative financial impact as they require continuous repair and renewal and increase the use of raw materials.

In the state of the art, for instance in Turkey, asphalt binders, asphalt emulsions, and cutback (liquid petroleum) asphalts are used in certain application ratios as tack coats on highways according to the Highway Technical Specification (2013). C60B2-3 and C65B2-3 bitumen emulsions are generally used in the tack coat in our provinces located in the 13th Regional Directorate of Highways (Antalya, Afyonkarahisar, Burdur, Isparta). While the relevant bitumen emulsions provide a bonding function between layers, deformation is inevitable after a certain period.

The application of the tack coat between the binder and wearing courses is of great importance for the performance of the asphalt pavement. While the use of different materials in the tack coat applied between the binder and wearing courses has been examined worldwide, there are no studies on double-layer asphalt specimens comprising the tack coat prepared in the laboratory environment. In the state of the art, the asphalt binder composition had to be formed due to the lack of an environmentally friendly binder comprising bio-oil obtained from the pyrolysis of waste recycled polypropylene (PP) in granular form.

In daily life, polypropylene (PP) plastic is used in products such as suitcases, bags, shaving cream and toothpaste tubes, sterile sanitary ware, flowerpots, office folders, buckets, and carpets. Polypropylene plastic used in many areas increases environmental pollution and becomes dysfunctional when it becomes waste. Therefore, the present disclosure aims to reduce environmental pollution, consumption of resources, and costs by recycling polypropylene and including it in the asphalt binder composition. In the related art, the applications regarding asphalt binders in the state of the art have been examined and are quoted below.

In the state of the art, the application with European Patent number EP06752151.8 and validated application number TR 2015/03854 in Turkey discloses a bituminous asphalt binder substances modified by the addition of crumb rubber or ground wheel rubber and a cross-bonding substance and methods relevant to the producing of the modified asphalt binder. This document describes the bonding of truck and/or car tires with a binder, in which, optionally, the modified asphalt binder may contain one or more polymer additives. No specific detail, property, and contribution of the polymer additive is mentioned.

The application CN105143326A entitled ‘Enhancing properties of sulfur extended asphalt using polyethylene wax’ discloses the use of olefinic polymers as modifiers. This document discloses that due to their non-polar structure, PE and PP are insufficient as they are almost completely insoluble in bitumen, and therefore their use is limited. Unlike the statements in document CN105143326A, in the present disclosure, PP is included in the asphalt binder composition in a recycled form, and the strength properties of the PP-modified asphalt binder are improved.

The study WO2014129758A1 on the inclusion of recycled material in an asphalt binder ingredient discloses a new high viscoelastic warm mix modifier composition to be added to an asphalt binder to reduce the quantity of greenhouse gas and toxic gas generated during the production of ascon in the asphalt pavement industry and to prevent the environmental pollution and a preparation method thereof.

The document WO2014129758A1 discloses that by recycling aggregate, waste of natural resources can be reduced, and by improving the public usability and extending the life of a pavement, maintenance costs can be saved. When the whole document is examined, it is understood that it is a study of asphalt concrete and it is about the use of recycled aggregate grains. Therefore, it is obvious that there are no studies on the recycling of polypropylene and its inclusion in the asphalt binder composition.

It is also known in the state of the art that there are studies with disclosures about the composition comprising polypropylene (PP). However, the polypropylene additive into the asphalt binder or using polypropylene by recycling is out of the question in the existing techniques and there are no techniques that address the benefits provided. The relevant documents are also quoted below.

One of the applications concerning polypropylene (PP) content is WO2022000059A1, entitled DURABLE ASPHALT MIX TO BE APPLIED COLD, and its abstract is as follows: ‘The invention relates to a durable asphalt mix to be applied cold, in which a hot mix is carried out in the same production plant as used for conventional asphalt production, said mix comprising penetration grade bitumen 35/50 and 50/70, natural and/or artificial aggregates provided in defined granulometric fractions, and a modifying agent in a proportion of between 20 and 35 wt. % in relation to the bitumen, which consists of between 30 and 60% water, between 10 and 40% polycyclic aromatic hydrocarbon compound, between 8 and 20% kerosene, between 5 and 18% atactic PP (polypropylene), and between 5 and 25% cyclohexamine. The hot processing temperature is between 13° and 160° C. for a period of approximately 120 minutes. This mix extends the shelf life of the product, which can be stored for up to 3 years, and allows the product to be applied cold.’ This technique discloses a durable asphalt mix to be applied cold comprising 5 to 18% atactic PP (polypropylene). There is polypropylene content, but there is no explanation about the binder used between the binder and wearing courses and the PP content of this binder.

Document CN104693821A, entitled ‘Bituminous mixture using DVS (direct vat set) high-adhesion modifier and preparation method thereof’, discloses the modified high-temperature coal-tar pitch. The document disclosed that Skeleton proppant is to be prepared by mixing 20-60 porous waste rubber powder, which has a mass ratio of 10-30:70-90, with PE, PP or recycled PE and PP. At present, the use of polymer-based materials in asphalt is known. This technique also refers directly to the use of PE, PP or their recycled forms and does not comprise any motivating information for its inclusion in an asphalt binder suitable for use as a tack coat.

In the related art, when document CN103086633A entitled ‘Warm mix anti-rutting asphalt mixing material and preparation method thereof’, document on the use of sterol mixtures as an additive in asphalt binder in the application with European Patent number EP17758664.1 and validated application number TR2020/15583 in Turkey, and document U.S. Pat. No. 10,435,537B2 entitled ‘Binder of vegetable origin, compositions comprising same and method for reducing the amount of petroleum-based bitumen’ describing a modified binder with a plant-based oil examined, it is seen that there is no study on the inclusion of recycled polypropylene in the asphalt binder composition.

In the state of the art, Superpave (Superior Performing Asphalt Pavement) Volumetric Mixture Design Method is a method that provides a high-performance pavement. In this method, which has only a 4% air void criterion, a gyratory press device is used to compress the specimens. Unlike the Marshall design method known in the present technique, the selection of aggregate and bitumen differs in terms of considering the traffic load and temperature values of the region to be applied. In the present disclosure, the binder and wearing courses were formed by the Superpave volumetric mixture design method.

In conclusion, due to the above-mentioned negativities and the inadequacy of the solutions on the subject, innovation is required for an asphalt binder composition modified with waste material in tack coat and production and application/use method thereof that is the subject of the invention.

### SUMMARY

The present disclosure relates to an asphalt binder composition modified with waste material in tack coat and production and application/use method thereof, which fulfils the above-mentioned requirements, eliminates all disadvantages, and brings some additional advantages.

Adjustments have been made at the critical values with embodiments of the invention; besides, development for the application of asphalt binder modified with waste material to the layers has been made.

With these and other embodiments of the invention, for the first time in Turkey, the properties, interfacial bond strengths, and optimum application ratios of tack coats (asphalt binder, bitumen emulsions) applied between binder and wearing courses have been determined in the laboratory environment.

By means of embodiments of the invention, the use of asphalt binders modified with waste material as a tack coat has been optimized for the first time.

With embodiments of the invention, the use of asphalt binder modified with waste material in the binding of asphalt layers contributes both economically and in terms of reducing environmental pollution.

Embodiments of the invention aim to increase the application of the tack coat by using asphalt binder modified with waste material instead of bitumen emulsions as the tack coat and to thereby reduce the deteriorations that may occur in the asphalt pavement.

Asphalt binder modified with waste material that is the subject of embodiments of the invention, the reduction of permanent deformation, fatigue, and thermal cracking on asphalt surfaces is provided.

With embodiments of the invention, good performance of the pavement, reduction of cost, and long service life are provided by providing the formation of good bonding between pavement layers.

With embodiments of the invention, double-layer asphalt specimens comprising a tack coat applied between the binder and wearing courses were prepared in the laboratory environment. Interfacial bond strengths were determined by performing a shear test on double-layer asphalt specimens. In addition to the interfacial bond strengths of the tack coats applied between the binder and wearing courses, it was determined for the first time that asphalt binder modified with waste material can be used as a tack coat.

Another aim of embodiments of the invention is enabling to the increasing the interfacial bond strength and dry indirect tensile strength values. As a result of the tests performed, the dry indirect tensile strength of the double-layer asphalt specimens comprising asphalt binder modified with waste material that is a subject of the disclosure increased by 11.36% and the interfacial bond strength increased by 47.72% compared to the known technical asphalt binders.

The structural and characteristic properties and all advantages of embodiments of the invention will be more clearly understood with reference to the figures and the detailed description of these figures below.

### BRIEF DESCRIPTION OF THE DRAWINGS

FIG. 1 shows the gradation curve of the wearing course according to some embodiments of the invention.

FIG. 2 shows the gradation curve of the binder course according to some embodiments of the invention.

FIG. 3 shows the graphs of the wearing course according to some embodiments of the invention.

FIG. 4 shows the graphs of the binder course according to some embodiments of the invention.

### DETAILED DESCRIPTION

In this detailed description, the preferred structuring of the production and application/use method of the asphalt binder composition modified with waste material in the tack coat is described only for a better understanding of the subject and without any limiting effect.

Asphalt binder modified with waste material that is the subject of embodiments of the invention comprises 97-99% asphalt binder and 1-3% waste material, which is bio-oil obtained from pyrolysis of waste recycled polypropylene (PP) in granular form and which increases the dry indirect tensile strength and interfacial bond strength.

The optimum values determined for asphalt binder modified with waste material that is the subject of embodiments of the invention are 2% bio-oil obtained from pyrolysis of waste recycled polypropylene (PP) in granular form and 98% asphalt binder which has a penetration grade 50/70.

Preparation of the asphalt binder modified with waste material that is the subject of embodiments of the invention comprises the process steps of:
Granulation of waste materials comprising polypropylene (PP),
Conversion of waste in granular form into bio-oil by burning with nitrogen gas in an oxygen-free environment in a pyrolysis device by staying in the reactor at 500±5° C. for 45±5 minutes,
Modification of 50/70 asphalt binder with bio-oil by mixing at 3000±50 rpm for 30±5 minutes at a temperature range of 155-165° C. in a temperature-controlled and high-speed mixer to ensure homogeneous distribution and mixing of bio-oil material in 50/70 asphalt binder using the wet process.

The method of applying asphalt binder modified with waste material that is the subject of embodiments of the invention as a tack coat to the binder and wearing courses comprises the process steps of:
Formation of the binder course,
Formation of the wearing course,
Preparation of the asphalt binder modified with waste material,
Application of asphalt binder modified with waste material on the binder course as a tack coat,
Addition of the prepared wearing course on the tack coat after asphalt binder modified with waste material is applied as a tack coat on the binder course,
Co-compaction of the layers in a gyratory compactor.

‘Formation of the binder course’ is performed with Superpave Volumetric Mixture Design, and it comprises the process steps of:
Preparation of aggregate gradation according to the binder course by considering the air void criterion,
Addition of asphalt binder,
Coating the aggregates with asphalt binder and compacting them by means of a gyratory compactor,
Determination of the optimum bitumen ratio corresponding to a given air void,
Formation of the binder course on the bitumen ratio and air void criteria calculated according to the Superpave volumetric mixture design.

‘Formation of the wearing course’ is performed with Superpave Volumetric Mixture Design, and it comprises the process steps of:
Preparation of aggregate gradation according to the wearing course by considering the air void criterion,
Addition of asphalt binder,
Coating the aggregates with asphalt binder and compacting them by means of a compactor,
Determination of the optimum bitumen ratio corresponding to a given air void,
Formation of the wearing course on the bitumen ratio and air void criteria calculated according to the Superpave volumetric mixture design.

The step ‘Application of asphalt binder modified with waste material on the binder course’ comprises the application process of asphalt binder modified with bio-oil obtained from pyrolysis of prepared waste recycled polypropylene in granular form as a tack coat on the binder course at a ratio of 0.15-0.50 l/m².

In the step ‘Application of asphalt binder modified with waste material on the binder course’, spraying asphalt binder modified with waste material on the binder course is the preferred application method. Alternatively, applications such as casting, dipping, and brushing can also be performed.

The method of applying the preferred asphalt binder modified with waste material of embodiments of the invention as a tack coat to the binder and wearing courses comprises the processes of:
Considering the criterion of 5% air void, adding asphalt binder to the aggregate gradation prepared according to the binder course at the ratios of 4, 4.5, 5, and 5.5%, respectively, then covering the aggregates completely with asphalt binder and compacting them by means of a gyratory compactor, determining the optimum bitumen ratio corresponding to 5% air void by controlling the minimum value of 13% for the voids in the mineral aggregate (VMA) for the binder course and the range of 60-75% for the voids filled with asphalt (VFA) in the design method, and according to Superpave Volumetric Mixture Design Method, considering 5% air void, determining the optimum bitumen ratio of the binder course as 4.78% and forming the binder course,
Considering the criterion of 4% air void, adding asphalt binder to the aggregate gradation suitable for the wearing course at the ratios of 4, 4.5, 5, and 5.5%, respectively, then covering the aggregates completely with asphalt binder and compacting them by means of a compactor, determining the optimum bitumen ratio corresponding to 4% air void by controlling the minimum value of 14% for the voids in the mineral aggregate (VMA) for the wearing course and the range of 65-75% for the voids filled with asphalt (VFA) in the design method, and according to Superpave Volumetric Mixture Design Method, considering 4% air void, determining the optimum bitumen ratio of the wearing course as 5.01% and forming the wearing course,
Granulation of waste materials which comprising polypropylene (PP), conversion of waste in granular form into bio-oil by burning with nitrogen gas in an oxygen-free environment in a pyrolysis device at 500±5° C. and during 45±5 minutes of staying in the reactor, modification of 50/70 asphalt binder with bio-oil by mixing at 3000±50 rpm for 30±5 minutes at a temperature range of 155-165° C. in a temperature-controlled and high-speed mixer to ensure homogeneous distribution of bio-oil material in 50/70 asphalt binder using the wet process, and obtaining asphalt binder modified with waste material,
Application of asphalt binder modified with bio-oil obtained from pyrolysis of waste recycled polypropylene in granular form as a tack coat on the binder course at a ratio of 0.15-0.50 l/m²,
After the asphalt binder modified with waste material is applied as a tack coat on the binder course, the binder course is taken back into the mold of the gyratory compactor; the prepared wearing course is added on top of the tack coat and compacted together.

If the type of aggregate, aggregate specific gravity, aggregate gradation, asphalt binder having different penetration grades used in the method described above and the location of the work change, the optimum bitumen ratio of the wearing and binder courses will vary. The values disclosed/calculated above do not limit the scope of prevention.

To ensure the bonding of the pavement layers, a tack coat is applied between the binder and wearing courses and a prime coat is applied between the base and binder courses. Within the scope of the study, asphalt binder modified with bio-oil obtained from pyrolysis of waste recycled polypropylene (PP) in granular form that is the subject of embodiments of the invention was developed for the first time in addition to the materials (asphalt binder, bitumen emulsions) specified in the Highway Technical Specification (2013) to be used as a tack coat applied between binder and wearing courses.

Polypropylene plastic, which is used in materials such as suitcases, bags, shaving cream and toothpaste tubes, sterile sanitary ware, flowerpots, office folders, buckets, and carpets in our daily life due to the increase in environmental pollution and the disposal problem of waste materials based on the increase in waste plastics at present, is preferred in embodiments of the invention. In embodiments of the invention, waste white fabric materials comprising polypropylene (PP), preferably obtained from textile factories, are granulated.

Mechanical recycling, chemical recycling, and energy recovery methods are used in the recycling of waste plastics. The recycling of plastic materials comprising polymers such as polyethylene, polypropylene, and polystyrene is enabled by the pyrolysis method, which is one of the chemical recycling methods, by means of burning in an oxygen-free environment.

Waste recycled polypropylene material in granular form was recycled by pyrolysis device by burning with nitrogen gas in an oxygen-free environment. As a result of the pyrolysis method, biochar and bio-oil materials were obtained from waste recycled polypropylene in granular form.

The temperature and the residence time of the material in the reactor affect the formation of the obtained materials. In embodiments of the invention, in the pyrolysis process performed to obtain bio-oil from the pyrolysis of waste recycled polypropylene in granular form, the temperature was determined as 500±5° C. and the residence time of the material in the reactor was 45±5 minutes.

Modification of asphalt mixtures with different materials is performed by dry and wet processes. In embodiments of the invention, the wet process is used by means of modifying the asphalt binder with bio-oil. A temperature-controlled and high-speed mixer was used to ensure homogeneous distribution and mixing of the bio-oil material in the asphalt binder.

Within the scope of the study, firstly, modification of asphalt binder with bio-oil obtained from pyrolysis of waste recycled polypropylene (PP) in granular form at 1, 2, and 3% ratios was performed. According to test results carried out on double-layer asphalt specimens comprising modified asphalt binders at 1, 2, and 3% ratios, since the highest values were obtained with the use of 2% modified asphalt binder, asphalt binders modified with intermediate values (1.5 and 2.5%) were not prepared. The optimum parameters used in bitumen modification are given in Table 1.

TABLE 1
Optimum parameters used in bitumen modification
Bitumen Modification

| | |
|---|---|
| Asphalt binder used | 50/70 asphalt binder |
| The material used in the | Bio-oil obtained from the pyrolysis of waste |
| modification | polypropylene in granular form |
| Modification method | Wet process |
| Device used | Temperature-controlled and high-speed mixer |
| Mixing speed | 3000 ± 50 rpm |
| Mixing temperature | 160 ± 5° C. |
| Mixing time | 30 ± 5 minutes |
| Mixing rates | 1, 2, and 3% |

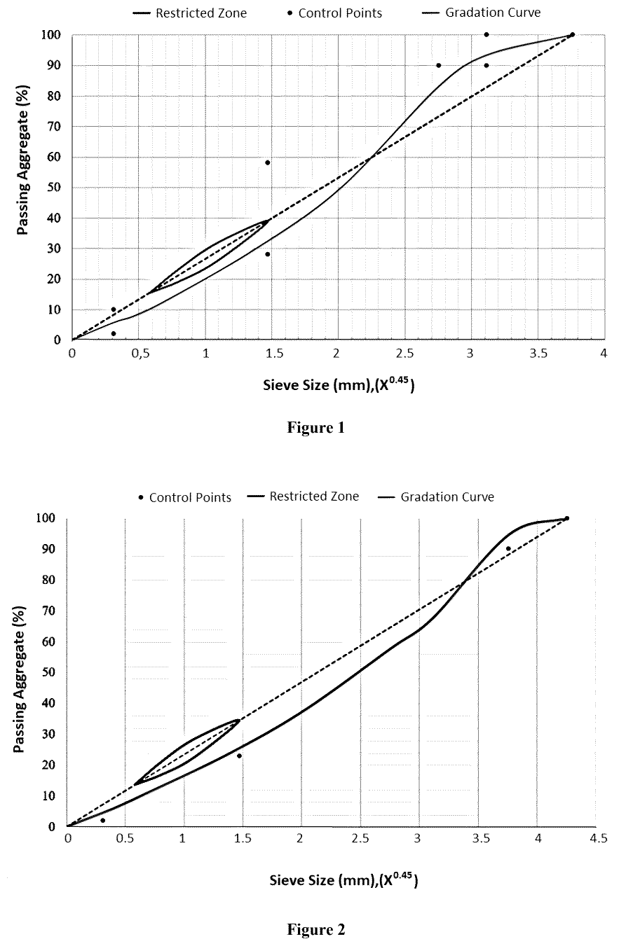

The limit values of aggregate gradations for binder and wearing courses specified in the Highway Technical Specification (2013) are given in Table 2-3. Within the scope of this disclosure, the gradation curves for the binder and wearing courses used in the production of double-layer asphalt specimens prepared according to the Superpave Volumetric Mixture Design method were determined for the first time in the laboratory environment by considering the aggregate gradation limit values given in the relevant tables (FIG. 1-2).

TABLE 2
Limit values of aggregate gradation for wearing course

| | | | Type-3 Ultra-thin |
|---|---|---|---|
| Sieve size (mm) | Type-1 | Type-2 | wearing |
| 19 (3/4″) | 100 | — | — |
| 12.5 (1/2″) | 88-100 | 100 | 100 |
| 9.5 (3/8″) | 72-90 | 80-100 | 90-100 |
| 6 (1/4″) | — | — | 25-33 |
| 4.75 (No. 14) | 42-52 | 55-72 | 23-31 |
| 2.00 (No. 10) | 25-35 | 36-53 | 20-27 |
| 0.425 (No. 40) | 10-20 | 16-28 | 12-18 |
| 0.180 (No. 80) | 7-14 | 8-16 | |
| 0.075 (No. 200) | 3-8 | 4-8 | 7-11 |

TABLE 3
Limit values of aggregate gradation for binder course

| Sieve size (mm) | % Passing |
|---|---|
| 25 (1″) | 100 |
| 19 (3/4″) | 80-100 |
| 12.5 (1/2″) | 58-80 |
| 9.5 (3/8″) | 48-70 |
| 4.75 (No. 14) | 30-52 |
| 2.00 (No. 10) | 20-40 |
| 0.425 (No. 40) | 8-22 |
| 0.180 (No. 80) | 5-14 |
| 0.075 (No. 200) | 2-7 |

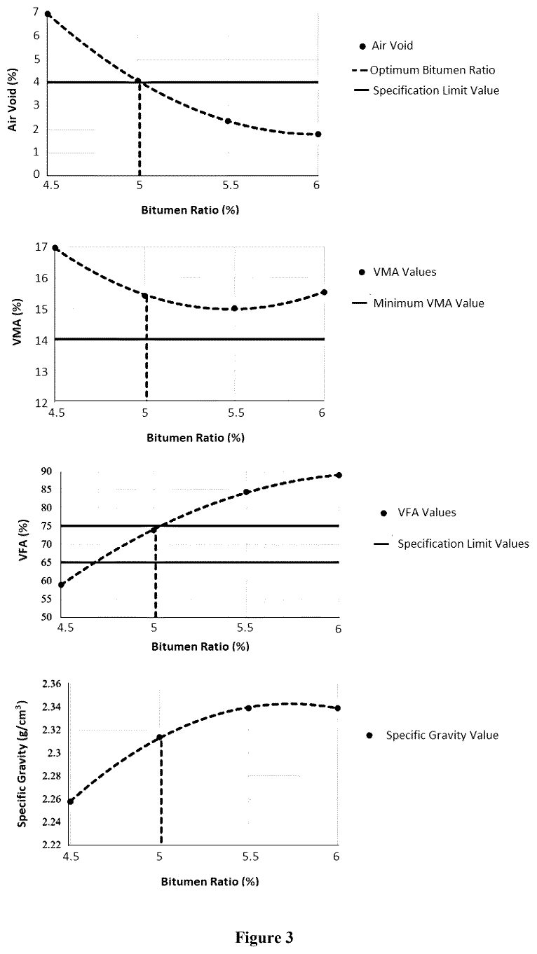

Firstly, four aggregate gradations were prepared to determine the optimum bitumen ratio of the wearing course. Considering the 4% air void criterion required for the wearing course in the design method, after adding asphalt binder to the prepared aggregate gradations at the ratios of 4, 4.5, 5, and 5.5%, respectively, it was ensured that the aggregates were completely covered with asphalt binder. Then, the prepared asphalt mixtures were compacted by means of a gyratory compactor. Firstly, the optimum bitumen ratio corresponding to 4% air void was marked from the air void graph. According to the optimum bitumen ratio marked, it was checked whether the minimum value of 14% for the voids in the mineral aggregate (VMA) and 65-75% for the voids filled with asphalt (VFA), which are other criteria required to seek for the wearing course in the design method, were met. After all controls were carried out, the optimum bitumen ratio for the wearing course was determined as 5.01% (FIG. 3).

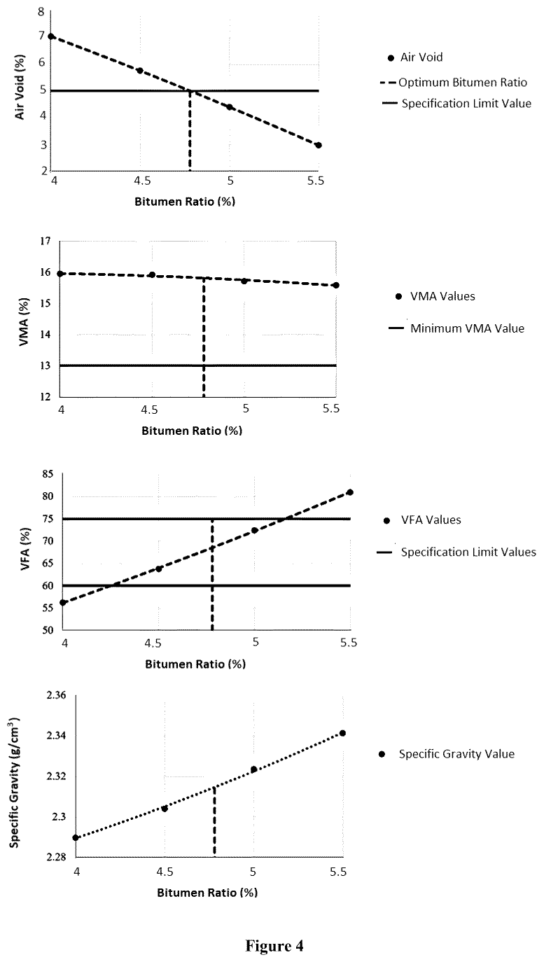

To determine the optimum bitumen ratio of the binder course, again four aggregate gradations were prepared, and then asphalt mixtures were prepared by adding asphalt binder at the ratios of 4, 4.5, 5, and 5.5%, respectively, considering the 5% air void criterion required for the binder course in the design method. For asphalt mixtures compacted by means of a gyratory compactor, the optimum bitumen ratio corresponding to 5% air void was marked on the air void graph. According to the optimum bitumen ratio marked, it was checked whether the minimum value of 13% for VMA and the range of 60-75% for VFA, which are other criteria required to seek for the binder course in the design method, were met. After all controls were carried out, the optimum bitumen ratio for the binder course was determined as 4.78% (FIG. 4).

To produce double-layer asphalt specimens, firstly, by means of a gyratory compactor, the binder course was prepared by compacting the mixture, which is obtained by adding 4.78% bitumen, which is the optimum bitumen ratio determined for the binder course, to the aggregate gradation suitable for the binder course.

After the binder course having a diameter of 100 mm and a height of approximately 70 mm was removed from the mold of the gyratory compactor, each of the materials 50/70 asphalt binder, C60B2-3 bitumen emulsion, and asphalt binder modified with bio-oil obtained from pyrolysis of waste recycled polypropylene in granular form at 1, 2, and 3% ratios were applied on the binder course at three application ratios each (0.15, 0.30, and 0.50 l/m²) as the tack coat.

After the tack coat was applied, the complete mixing of aggregates with bitumen was ensured by adding 5.01% bitumen, which is the optimum bitumen ratio determined for the wearing course, to the aggregate gradation suitable for the wearing course. After the binder course, on which the tack coat was applied, was taken into the mold of the gyratory compactor again, the prepared wearing course and the tack coat are compacted together by adding the prepared wearing course onto the tack coat. Thus, double-layer asphalt specimens having a diameter of 100 mm and a height of approximately 140 mm comprising tack coats applied separately between the binder and wearing courses in three ratios each, using three different materials, were produced.

To determine the tensile strength performance of the tack coat applied between the binder and wearing courses, an Indirect Tensile Strength (ITS) test was performed according to the AASHTO T283 standard. Two sets were prepared such that each of which has three asphalt specimens for the conditioned and unconditioned double-layer asphalt specimens. The prepared double-layer asphalt specimens were kept in a drying oven having a temperature of 40° C. for 72 hours. The unconditioned double-layer asphalt specimens were kept in a drying oven having a temperature of 25° C. until the test steps to be performed on the conditioned asphalt specimens were completed. After the double-layer asphalt specimens to be conditioned were placed in a water bath having a temperature of 25° C. for 24 hours, and then they reached 55-80% saturation degrees by vacuum treatment at the end of the period, they were placed in a freezer having a temperature of −18° C. for 16 hours. The double-layer asphalt specimens taken from the freezer were placed in a water bath having a temperature of 60° C. for 24 hours. Then, the asphalt specimens extracted from the water bath were placed in a water bath having a temperature of 25° C. for 2 hours. The unconditioned (ITS_{dry}) and conditioned (ITS_{wet}) indirect tensile strengths of the asphalt specimens were calculated as follows by applying 51 mm/min load to the conditioned and unconditioned double-layer asphalt specimens having a temperature of 25° C.:

$$ITS = ( 2 \times P ) / ( π \times h \times D ) \qquad ( 1 )$$

Here, ITS represents the indirect tensile strength (kPa), P represents the peak load at fracture moment (kN), h represents the height of the specimen (m), and D represents the diameter of the specimen (m).

The tensile strength ratio of conditioned specimens to the tensile strength of unconditioned specimens is defined as the Tensile Strength Ratio (TSR) at the test result. TSR value is calculated by means of the equation given below:

$$TSR = {ITS}_{( Wet ) /} {ITS}_{( Dry )} \times 100 \qquad ( 2 )$$

Here, TSR represents the tensile strength ratio (%), ITS_{(Wet)} represents the indirect tensile strength of the conditioned specimen, and ITS_{(Dry)} represents the indirect tensile strength of the unconditioned specimen.

To evaluate the shear strength performance of the tack coat applied between the binder and wearing courses, shear tests were carried out on double-layer asphalt specimens. The interfacial bond strength of the double-layered asphalt specimens was determined using a shearing head by means of a Marshall test machine applying a load of 51 mm/min. After the double-layer asphalt specimens comprising the tack coat were prepared, they were kept in a drying oven at 45±5° C. for 2 hours, and then shear tests were carried out on the specimens at the end of this period. The interfacial bond strengths of double-layer asphalt specimens are calculated as follows:

$$τ = P / A \qquad ( 3 )$$

Here, t represents the shear stress (kPa), P represents the applied peak load (kN), and A represents the area of the specimen (m²).

According to the ITS test results, among the double-layer asphalt specimens prepared with the materials used as a tack coat in three application ratios, the highest dry indirect tensile strength was given by the double-layer asphalt specimens comprising asphalt binder modified with 2% waste material.

The usability of the asphalt binder modified with waste material in the tack coat was determined for the first time with the study that is the subject of embodiments of the invention. When Table 4 is analyzed, it is seen that the dry indirect tensile strength of the double-layer asphalt specimens comprising asphalt binder modified with 2% waste material increased by 11.36% compared to the dry indirect tensile strength of the double-layer asphalt specimens with no tack coat. It is aimed that the use of asphalt binder modified with waste material in the tack coat will contribute both economically and in terms of reducing the disposal problem of waste materials.

TABLE 4
ITS and TSR values of double-layer asphalt
specimens comprising the tack coat

| | | | Wet | |
|---|---|---|---|---|
| | | | Indirect | |
| | | | Tensile | |
| | Tack Coat | Dry Indirect | Strength | |
| Tack Coat | Application | Tensile Strength | (ITS_{wet}) | TSR |
| Material | Ratios (l/m²) | (ITS_{dry}) (kPa) | (kPa) | (%) |
| 50/70 Asphalt | 0 | 951 | 941 | 99 |
| Binder | 0.15 | 1049 | 872 | 83 |
| | 0.30 | 887 | 810 | 91 |
| | 0.50 | 760 | 732 | 96 |
| C60B2-3 Bitumen | 0.15 | 966 | 844 | 87 |
| Emulsion | 0.30 | 951 | 796 | 84 |
| | 0.50 | 950 | 791 | 83 |
| 1% Modified Binder | 0.15 | 861 | 821 | 95 |
| | 0.30 | 832 | 765 | 92 |
| | 0.50 | 1019 | 829 | 81 |
| 2% Modified Binder | 0.15 | 1038 | 842 | 81 |
| | 0.30 | 1059 | 847 | 80 |
| | 0.50 | 874 | 776 | 88 |
| 3% Modified Binder | 0.15 | 842 | 800 | 95 |
| | 0.30 | 968 | 804 | 83 |
| | 0.50 | 943 | 789 | 84 |

The interfacial bond strengths of double-layer asphalt specimens comprising materials 50/70 asphalt binder, C60B2-3 bitumen emulsion, and asphalt binder modified with waste material applied separately at three application ratios (0.15, 0.30, and 0.50 l/m²) as a tack coat between binder and wearing courses were compared by shear test. Again, double-layer asphalt specimens prepared with asphalt binder modified with 2% waste material gave better interfacial bond strength than the materials (50/70 asphalt binder, C60B2-3 bitumen emulsion) specified in the Highway Technical Specifications (2013) to be used as a tack coat. The results obtained from the shear test show that the interfacial bond strength of the double-layer asphalt specimens comprising asphalt binder modified with 2% waste material increased by 47.72% compared to the interfacial bond strength of the double-layer asphalt specimens with no tack coat (Table 5).

TABLE 5
Interfacial bond strength of double-layer
asphalt specimens comprising the tack coat

| | Tack Coat | Interfacial |
|---|---|---|
| | Application | Bond Strengths |
| Tack Coat Materials | Ratios | (kPa) |
| 50/70 Asphalt Binder | 0 | 308.727 |
| | 0.15 | 275.950 |
| | 0.30 | 270.331 |
| | 0.50 | 260.342 |
| C60B2-3 Bitumen Emulsion | 0.15 | 287.812 |
| | 0.30 | 328.393 |
| | 0.50 | 255.035 |
| 1% Modified Asphalt Binder | 0.15 | 351.805 |
| | 0.30 | 306.668 |
| | 0.50 | 409.242 |
| 2% Modified Asphalt Binder | 0.15 | 371.159 |
| | 0.30 | 456.066 |
| | 0.50 | 374.592 |
| 3% Modified Asphalt Binder | 0.15 | 407.681 |
| | 0.30 | 332.139 |
| | 0.50 | 310.287 |

By means of embodiments of the invention, for the first time, double-layer asphalt specimens comprising a tack coat applied suitably by the Superpave Volumetric Mixture Design method between the binder and wearing courses in the laboratory environment were prepared. This is the first time that the ITS test and shear test have been carried out on double-layer asphalt specimens prepared with the materials specified in the Highway Technical Specifications (2013) for use as a tack coat. In addition, the usability of asphalt binders modified with bio-oil, which are obtained from pyrolysis of waste recycled polypropylene in granular form, as a tack coat in asphalt mixtures was determined for the first time.

1. A modified asphalt binder made of asphalt binder modified with waste material, the modified asphalt binder for application between a binder course and a wearing course and providing bonding, the modified asphalt binder comprising:
1-3% waste material and 97-99% asphalt binder, wherein the modified asphalt binder exhibits increased dry indirect tensile strength and interfacial bond strength compared to the asphalt binder without modification.

2. The modified asphalt binder according to claim 1, wherein the waste material is a bio-oil obtained from pyrolysis of waste recycled polypropylene (PP) in granular form.

3. The modified asphalt binder according to claim 1, wherein the asphalt binder is an asphalt binder having penetration grade 50/70.

4. A method of preparing asphalt binder modified with waste material, the method comprising:
granulating waste materials comprising polypropylene (PP),
converting the granulated waste materials into bio-oil by burning in a pyrolysis device, and
modifying asphalt binder with the bio-oil by a wet method.

5. The method of preparing asphalt binder modified with waste material according to claim 4, wherein the burning further comprises burning with nitrogen gas in an oxygen-free environment in the pyrolysis device by staying in a reactor at 500±5° C. for 45±5 minutes.

6. The method of preparing asphalt binder modified with waste material according to claim 4, wherein the modifying further comprises mixing at 3000±50 rpm for 30±5 minutes at a temperature range of 155-165° C. in a temperature-controlled and high-speed mixer to ensure homogeneous distribution and mixing of the bio-oil material.

7. A method of applying asphalt binder modified with waste material as a tack coat to the binder and wearing courses, the method comprising:
forming a binder course,
forming a wearing course,
preparing an asphalt binder modified with waste material,
applying the asphalt binder modified with waste material on the binder course as a tack coat,
adding the formed wearing course on the tack coat after the asphalt binder modified with waste material is applied as the tack coat on the binder course, and
co-compacting the binder course, tack coat, and wearing course in a gyratory compactor.

8. The method of applying asphalt binder modified with waste material as a tack coat to binder and wearing courses according to claim 7, wherein the forming the binder course is performed with Superpave Volumetric Mixture Design comprising:
preparing aggregate gradation according to the binder course by considering an air void criterion,
adding the asphalt binder,
coating aggregates with the asphalt binder and compacting the aggregates using the gyratory compactor,
determining an optimum bitumen ratio corresponding to a given air void,
forming the binder course based on the optimum bitumen ratio and the air void criterion calculated according to the Superpave Volumetric Mixture Design.

9. The method of applying asphalt binder modified with waste material as a tack coat to binder and wearing courses according to claim 8, wherein the forming the binder course further comprises using a 5% air void in the aggregate gradation according to the Superpave Volumetric Mixture Design, and wherein the optimum bitumen ratio is 4.78%.

10. The method of applying asphalt binder modified with waste material as a tack coat to binder and wearing courses according to claim 8, wherein the forming the binder course further comprises:
considering a criterion of 5% air void, adding the asphalt binder to the aggregate gradation prepared according to the binder course at ratios of 4, 4.5, 5, and 5.5%, respectively, then covering the aggregates completely with the asphalt binder and compacting the aggregates using the gyratory compactor,
determining an optimum bitumen ratio corresponding to the 5% air void by controlling a minimum value of 13% for voids in a mineral aggregate (VMA) for the binder course and a range of 60-75% for voids filled with asphalt (VFA) in the Superpave Volumetric Mixture Design method, and
according to the Superpave Volumetric Mixture Design Method, considering the 5% air void, determining the optimum bitumen ratio of the binder course as 4.78%, and forming the binder course.

11. The method of applying asphalt binder modified with waste material as a tack coat to binder and wearing courses according to claim 7, wherein the forming the wearing course is performed with the Superpave Volumetric Mixture Design and further comprises:
preparing aggregate gradation according to the binder course by considering an air void criterion,
adding the asphalt binder,
coating the aggregates with the asphalt binder and compacting the aggregates using a compactor,
determining the optimum bitumen ratio corresponding to a given air void,
forming the wearing course on the bitumen ratio and the air void criterion calculated according to the Superpave Volumetric Mixture Design.

12. The method of applying asphalt binder modified with waste material as a tack coat to binder and wearing courses according to claim 8, wherein the forming the wearing course is performed with an optimum bitumen ratio of 5.01%, and wherein a 4% air void criterion is considered according to the Superpave Volumetric Mixture Design.

13. The method of applying asphalt binder modified with waste material as a tack coat to the binder and wearing courses according to claim 8, wherein the forming the wearing course further comprises:
considering a criterion of 4% air void, adding the asphalt binder to the aggregate gradation suitable for the wearing course at ratios of 4, 4.5, 5, and 5.5%, respectively, then covering the aggregates completely with asphalt binder and compacting the aggregates using a compactor,
determining an optimum bitumen ratio corresponding to 4% air void by controlling a minimum value of 14% for voids in the mineral aggregate (VMA) for the wearing course and a range of 65-75% for the voids filled with asphalt (VFA) in the Superpave Volumetric Mixture Design method, and
according to the Superpave Volumetric Mixture Design Method, considering the 4% air void, determining the optimum bitumen ratio of the wearing course as 5.01%, and forming the wearing course.

14. The method of applying asphalt binder modified with waste material as a tack coat to binder and wearing courses according to claim 7, wherein the preparing the asphalt binder further comprises:
granulating waste materials comprising polypropylene (PP),
converting the waste in granular form into bio-oil by burning with nitrogen gas in an oxygen-free environment in a pyrolysis device at 500±5° C. and for 45±5 minutes in a reactor,
modifying 50/70 asphalt binder with the bio-oil by mixing at 3000±50 rpm for 30±5 minutes at a temperature range of 155-165° C. in a temperature-controlled and high-speed mixer to ensure homogeneous distribution of the bio-oil material in the 50/70 asphalt binder using a wet process.

15. The method of applying asphalt binder modified with waste material as a tack coat to binder and wearing courses according to claim 7, wherein the
applying the asphalt binder is performed at a ratios of 0.15-0.50 l/m².

16. The method of applying asphalt binder modified with waste material as a tack coat to binder and wearing courses according to claim 7, wherein the applying the asphalt binder is performed by spraying.
